(19) United States
(12) Patent Application Publication
(10) Pub. No.: US 2026/0237023 A1
(43) Pub. Date: Aug. 13, 2026

(54) SYSTEM AND METHOD FOR GENERATING AN ALL-IN-FOCUS IMAGE FROM MULTI-FOCUS IMAGES

(71) Applicant: Hong Kong Applied Science and Technology Research Institute Co., Ltd., Shatin (HK)

(72) Inventors: Shangping LIU, Tai Wai (HK); Tianxiao XU, Sha Tin (HK); Lu WANG, Tai Po (HK)

(21) Appl. No.: 19/051,711

(22) Filed: Feb. 12, 2025

(51) Int. Cl. G06T 5/50; G06T 5/20; G06T 5/70; G06T 7/55

(52) U.S. Cl. CPC G06T 5/50; G06T 5/20; G06T 5/70; G06T 7/55; G06T 2207/10024; G06T 2207/10148; G06T 2207/20016; G06T 2207/20221

(57) ABSTRACT

A computer-implemented method of fusing multiple images, where the multiple images are taken at different focal planes on a same field of view (FOV). The method includes the steps of a) to each one of the multiple images, performing Laplacian pyramid decomposition to generate a first pyramid; b) fusing the first pyramids of the multiple images to obtain a fused pyramid under guidance of energy maps respectively corresponding to each one of the multiple mages; c) performing a dynamic weighting of the fused pyramid to generate a weighted pyramid; and d) reconstructing a fusion image of the FOV from the weighted pyramid. The invention provides further a computer-implemented method of generating a depth map based on multiple images.

### FIELD OF INVENTION

This invention relates to digital image processing, and in particular to methods and systems for generating an all-in-focus image from multi-focus images.

### BACKGROUND OF INVENTION

Digital microscopy is an advanced imaging technique that combines traditional microscopy with digital technology. Instead of using eyepieces, digital microscopes use a digital camera to capture images or video that can then be displayed on a computer monitor or other electronic device. This allows for improved visualization, easy documentation and sharing of findings.

One of the main limitations of conventional digital microscopy is depth of field. Depth of field refers to the range of distances at which objects appear sharp and in focus. Conventional optical lenses have a limited depth of field, meaning that only a small portion of the specimen is in focus at any given time. This limitation makes it difficult to capture clear images of specimens of varying depth. Using a small aperture alone to extend the depth of field is often not feasible in digital microscopy due to light limitation, diffraction and signal-to-noise ratio considerations.

Extended Depth of Focus (EDoF) combines multiple images taken at different focal planes into a single image where all parts of the specimen are in focus. On the other hand, 3D imaging calculates depth information by analyzing the degree of focus of a series of 2D images taken at different focal planes and reconstructs the 3D shape of an object. Both EDoF and 3D imaging provide a comprehensive view of the specimen, overcoming the limitations of traditional optical lenses, which have a limited depth of field, and provide detailed and accurate imaging. They make digital microscopes more versatile and valuable in various applications such as life sciences, materials science and industrial inspection.

For the Laplacian pyramid method, the image generated by the conventional Laplacian pyramid usually has inaccurate colors and brightness. The conventional Laplacian pyramid method cannot handle well the glare and fine-textured area which are common cases in digital microscopy.

For the depth from focus (DFF) method, it can be used for both EDoF and 3D imaging. Estimating depth in low textured and homogeneous areas is difficult because there is insufficient contrast to accurately determine sharpness. Inaccuracies in depth data result in less smooth and obvious artifacts in EDOF images generated by DFF, especially near object edges.

### SUMMARY OF INVENTION

In the light of the foregoing background, it is an object of the present invention to provide an improved Laplacian pyramid method to generate EDOF image. Another object of the present invention is to provide and an improved DFF method to generate depth map.

The above object is met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

Accordingly, the present invention in one aspect is a computer-implemented method of fusing multiple images, where the multiple images are taken at different focal planes on a same field of view (FOV). The method includes the steps of a) to each color channel of each one of the multiple images, performing Laplacian pyramid decomposition to generate a first pyramid; b) for color channel, fusing the first pyramids of the color channel of the multiple images to obtain a fused pyramid for the color channel under guidance of energy maps respectively corresponding to each one of the multiple mages; c) performing a dynamic weighting of the fused pyramid to generate a weighted pyramid for each color channel; d) reconstructing a channel fusion image for each color channel from the weighted pyramid; and e) merging the channel fusion images of all the color channels to obtain a final fused image.

In some embodiments, the method further contains a Step f) which is that for each one of the multiple images, the energy map is calculated using a linked Laplacian pyramid decomposition.

In some embodiments, Step f) further includes a Step g) which is for each one of the multiple images, performing the linked Laplacian pyramid decomposition to generate a second pyramid, during which information of a bottom layer of the second pyramid is gradually introduced to a top layer of the corresponding pyramid by applying weighted averages.

In some embodiments, the method further includes, before Step f), a step of converting the one of the multiple images to a grayscale image, and using the grayscale image for performing the linked Laplacian pyramid decomposition.

In some embodiments, Step e) further includes a Step g) which is conducting Gaussian smoothing to the second pyramid to obtain the energy map for each one of the multiple images.

In some embodiments, in Step b) a pixel that has a highest energy among all similar pixels in the multiple images is chosen as a pixel in the fused pyramid.

In some embodiments, in Step c) a linear function is applied to the fused pyramid, such that weights of a first plurality of layers of the fused pyramid are enhanced, and weights of a second plurality of layers of the fused pyramid are reduced.

According to another aspect of the invention, there is provided a computer-implemented method of generating a depth map based on multiple images which are taken at different focal planes on a same FOV. The method includes the steps of: a) for each one of the multiple images, conducting focus measurement to generate an initial focus map; b) estimating an uncertainty map for the multiple images based on the initial focus maps; c) refining the initial focus maps according to the uncertain map and a fusion image of the multiple images to obtain filtered focus maps; and d) conducting depth acquisition on the filtered focus maps to generate the depth map.

In some embodiments, Step b) further contains the steps of: e) calculating peak signal-to-noise ratio (PSNR) of each pixel in the FOV based on the initial focus maps; and f) generating the uncertain map based on results of comparison between the PSNR of each said pixel and a threshold.

In some embodiments, in Step e) the PSNR of each said pixel is calculated based on a mean-square-error (MSE) of the pixel and a maximum focus value of the pixel.

In some embodiments, Step c) further contains the steps of: g) masking out uncertainty areas in the initial focus maps based on the uncertainty; and applying a guided filter based on the fusion image to the initial fusion maps to obtain the filtered focus maps.

In some embodiments, the method further includes the steps of: i) performing a topmost focus detection on the filtered focus maps; and j) based on a result of the topmost focus detection and the depth map, generating a final depth map.

In some embodiments, Step i) further includes finding a topmost local peak for each pixel in the FOV in order to generate a topmost depth map. Step j) further includes selecting a preferable topmost depth for each said pixel in the FOV based on the uncertainty map; and generating the final depth map based on the preferable topmost depths of the pixels.

According to a further aspect of the invention, there is provided a non-transitory computer-readable medium, having stored thereon program instructions that, upon execution by a computing device, cause the computing device to perform any of the methods or their variations as described above.

According to a further aspect of the invention, there is provided a computing system that contains one or more processors; and memory containing instructions that, when executed by the one or more processors, cause the computing system to perform any of the methods or their variations as described above.

According to a further aspect of the invention, there is provided a method to generate all-in-focus image and depth map from a series of multi-focus images. The method includes the steps of an image fusion method from a series of multi-focus images, and a depth estimation method from a series of multi-focus images. In particular, the image fusion method includes Laplacian pyramid decomposition for a series of multi-focus images, linked Laplacian pyramid decomposition to generate energy maps, Laplacian pyramids fusion, dynamic weighting of Laplacian pyramid, and reconstruction from Laplacian pyramid to generate fusion image. The depth estimation method includes focus measurement from a series of multi-focus images to generate focus maps, uncertainty map estimation from focus maps, focus maps refinement with uncertainty masking and fusion image guidance, and depth acquisition with topmost focus detection from focus maps.

Thus, embodiments of the invention provide numerous advantages over the traditional Laplacian pyramid method for image fusion and the DFF method for depth map generation. For example, the improved Laplacian pyramid method according to one embodiment of the invention, which uses energy-guided image fusion and dynamic weighting, is capable of generating EDoF images that have better anti-glare capability, and the method also keeps the color and brightness of the generated image consistent with the input image. In another example, the improved DFF method according to an embodiment of the invention refines focus maps based on the estimated uncertainty map and the fusion image generated by the improved Laplacian pyramid method as mentioned above, and performs depth acquisition with topmost focus detection on the filtered focus maps, which improves the depth accuracy of the depth map, especially in the low texture area.

### BRIEF DESCRIPTION OF FIGURES

The foregoing and further features of the present invention will be apparent from the following description of preferred embodiments which are provided by way of example only in connection with the accompanying figures, of which:

FIG. 1 shows the general flow of methods of fusing multi-focus images and depth estimation according to a first embodiment of the invention.

FIG. 2 shows detailed steps of fusing multi-focus images in the method of FIG. 1.

FIG. 3 illustrates the principle of linked Laplacian pyramid decomposition in the method of FIG. 2.

FIG. 4 shows the process of estimating an uncertainty map for the depth estimation in the method of FIG. 1.

FIG. 5 illustrates the Gauss interpolation in the process of estimating the uncertainty map of FIG. 4.

FIG. 6 shows detailed steps of refining focus maps for the depth estimation in the method of FIG. 1.

FIG. 7 shows detailed steps of conducting topmost focus detection for the depth estimation in the method of FIG. 1.

FIG. 8a illustrates the PSNR comparison between fusion results using the image fusion method according to an exemplarity embodiment of the invention and ground truth.

FIG. 8b illustrates the root mean squared error (RMSE) comparison between estimated depth maps generated using a method according to an exemplarity embodiment of the invention and ground truth.

FIG. 9 is a block diagram of an example computing device suitable for use in implementing some embodiments of the present disclosure.

### DETAILED DESCRIPTION OF THE PREFERRED EMBODIMENTS

Embodiments of the invention provide both an improved Laplacian Pyramid method used to generate the EDOF image and an improved DFF method used to generate the depth map. With these methods, a hybrid “Laplacian Pyramid+DFF” solution is provided to produce a realistic all-in-focus image as well as an accurate depth map, allowing for more comprehensive sample observation, analysis, and measurement. The enhanced Laplacian Pyramid method provides better glare suppression and keeps the color and brightness of the generated image consistent with the input image. In addition, the method produces a more detailed and visually appealing image. On the other hand, the enhanced DFF method uses the detailed fusion image generated from the Laplacian pyramid to perform depth map estimation. The uncertainty-revealed focus maps as they are refined are used to improve the depth accuracy, especially in the low texture area.

Turning to FIG. 1, in which a method is illustrated which is adapted to generate both a fusion image from multiple images taken at different focal planes on a same FOV, and a depth map based on the multiple images. The depth map is generated in a process guided by the generated fusion image generated, although substantially the fusion image and the depth map are generated in different, parallel data processing streams of the method. The fusion image contains good representations of details, edges, objects, etc. of the FOV, however it does not contain the depth information. Therefore, a depth map needs to be separately generated, and the fusion image is used as a guide during the depth map estimation.

In particular, the method starts with an image sequence 20 containing multiple images being provided as the input to the method. The multiple images were taken at different focal planes in the same FOV as mentioned above, for example by an digital imaging system. In one example, for the inspection of a specimen by a digital microscope, the FOV is the observable area that the microscope captures on part of the specimen. As skilled persons in the art would understand, the FOV is determined by the magnification and the size of the detector array (such as a digital camera sensor) used in the microscope. The multiple images in the image sequences therefore capture substantially the same object/scene, but they were taken at different focal distances. It is therefore needed to combine all these images into a single image by fusion, retaining the important features from each of the original images. In addition, a depth map is desired for the fusion image, as the depth essentially captures the variations in height or depth across the surface of the specimen, providing a 3D perspective.

As shown in FIG. 1, there are two main streams of data processing in the method, the first one indicated by the image fusion path in the figure, and the second one indicated by the depth estimation path in the figure. For the image fusion path, the multiple images from the image sequence are processed using Laplacian pyramid decomposition in Step 22, and then Laplacian pyramids generated for the multiple images in Step 22 are fused in Step 24 as guided by energy maps (which will be described in more details later). The fused pyramid then undergoes dynamic weighting in Step 26, and finally a fusion image 30 is generated in Step 28 by reconstruction from the fused pyramid. For the depth estimation path, the multiple images from the image sequence undergo focus measurement in Step 32 so that focus maps 34 for the multiple images are generated. The focus maps 34 are used to estimate an uncertainty map 38 in Step 36, and in Step 37 the uncertainty map 38 together with the fusion image 30 as generated previously are used to refine the focus maps 34, resulting in filtered focus maps 40. Then, a depth acquisition with topmost focus detection is applied to the filtered focus maps 40 in Step 42, resulting in the final depth map 44.

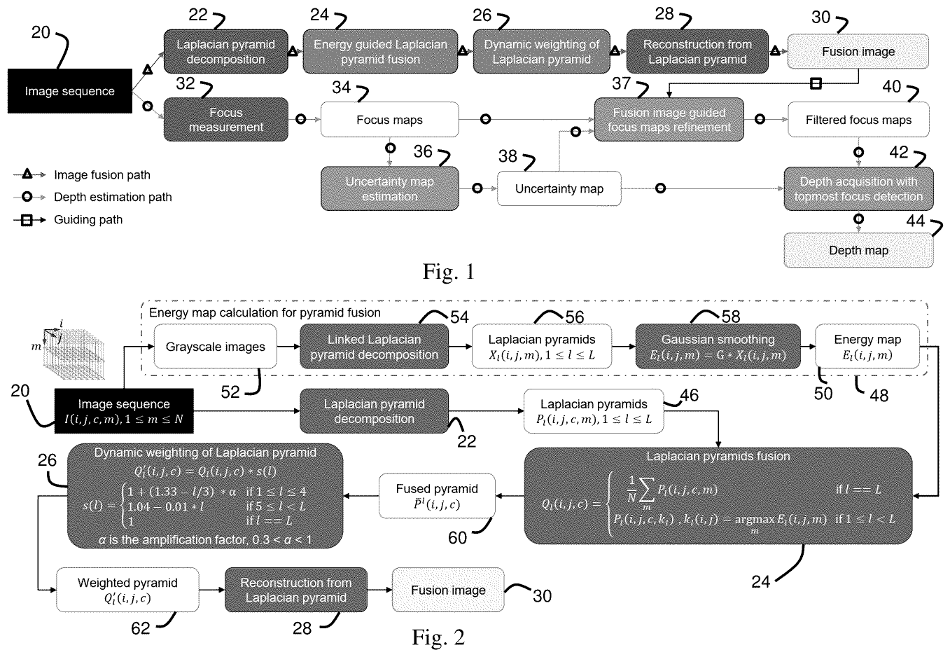

Detailed operations of function blocks, modules, and intermediate products generated by the above as shown in FIG. 1 will now be described in detail. FIG. 2 illustrates specific method steps and algorithms applied in the image fusion path of FIG. 1. Assume that the image sequence 20 contains multiple images with every pixel in each one of the multiple images represented by I(i, j, c, m), where m is the index of the image in the sequence, i, j are the coordinates of the pixel on orthogonal axes (see the upper-leftmost insert in FIG. 2) in the FOV, and c is the index of color channel. For example, for each color image there are three color channels which are R, G and B, so the value of c is either 0, 1 or 2. Apparently, 1≤m≤N, where N is the total number of images in the image sequence 20. As mentioned above, Laplacian pyramid decomposition is performed on all images in the image sequence 20 in Step 22, and in particular, the Laplacian pyramid decomposition is performed on each one of the images such that a Laplacian pyramid 46 is generated for every image in the image sequence 20. For example, suppose that there are 100 images in the image sequence 20, then after Step 22 is carried out there will be 300 Laplacian pyramids 46 generated, and there are three Laplacian pyramids 46 corresponding to each color channel of each image in the image sequence 20. The Laplacian pyramids 46 generated in Step 22 are represented by Pₗ(i, j, c, m), where 1≤l≤L, and L is the total number of layers in a Laplacian pyramid 46, while l is the index of a layer in the pyramid 46. The Laplacian pyramid decomposition used in Step 22 could be those commonly used in the digital microscopy field as skilled persons would understand, and it involves creating a series of band-pass filtered images (known as “layers”) that capture different levels of detail. The Laplacian pyramid decomposition used in Step 22 will not be described in more details herein.

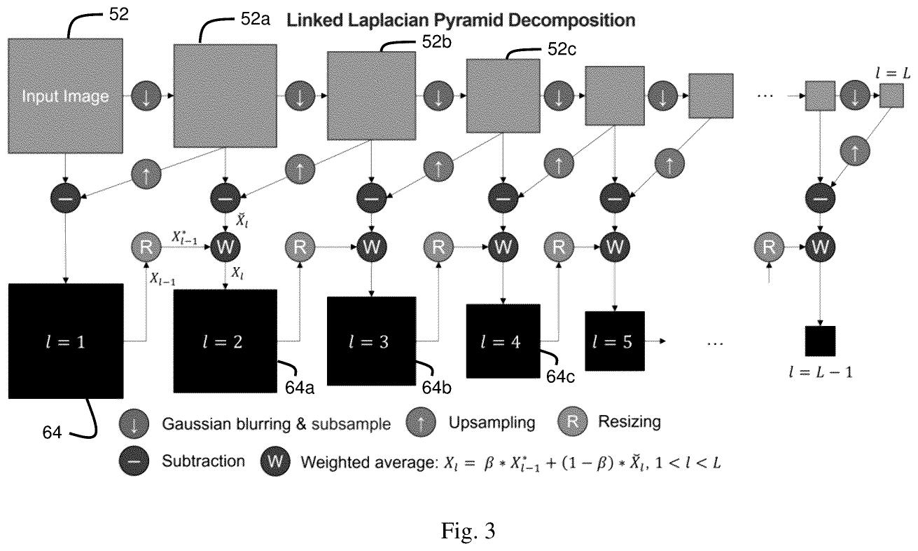

In parallel with Step 22, energy maps 50 are also generated in a separate path denoted by box 48 in FIG. 2. To generate the energy maps 50, the multiple images in the image sequence 20 are firstly converted to grayscale images 52. The purpose of this conversion is to maintain color consistency and accuracy. Suppose that one computes an energy map separately for each of the R, G, and B channels, the resulting fused pyramid might have the R, G, and B channel values for the same pixel selected from different source images (from the image sequence 20). To prevent this, the energy map of the grayscale channel is used to guide the fusion of the R, G, and B channels, ensuring consistency across all color channels. Then, in Step 54 the grayscale images 52 undergo a linked Laplacian pyramid decomposition. FIG. 3 best illustrates the working principle of the linked Laplacian pyramid decomposition, which is somehow different from conventional Laplacian pyramid decomposition methods, or the Laplacian pyramid decomposition in Step 22. In particular, for each of the grayscale images 52 (which is denoted as “Input Image” in FIG. 3), Gaussian blurring and subsampling is applied iteratively for L−1 times, where L is the number of layers (or depth) of the Laplacian pyramid. During the above process band-pass images 52a, 52b, 52c . . . are generated with gradually lower resolutions and thus becoming more global. In other words, the input image (the grayscale image 52) has the highest resolution.

For each one of the input image and the band-pass images 52a, 52b, 52 (except the last band-pass image at l=L), its next band-pass image is upsampled (which is to increase its resolution), and then the upsampled image is subtracted from the current image to get the Laplacian pyramid level (layer) corresponding to the current band-pass image. For example, after the band-pass image 52a is generated based on the input image, the band-pass image 52a is upsampled, and then is subtracted from the input image, resulting in the first Laplacian pyramid level 64. The upsampling and subtraction operations repeat L−1 times for generating all L−1 layers of the Laplacian pyramid 56 resulted from the linked Laplacian pyramid decomposition. Note that the Laplacian pyramid 56 generated by the method of FIG. 3 is independent from the Laplacian pyramids 46 generated by Step 22 in the parallel path, although they are the same in number of layers and both come from the same multiple images in the image sequence 20.

The downsampling, upsampling, and subtraction operations described above are known in conventional Laplacian pyramid decomposition methods. However, in the method of FIG. 3, what is different as compared to prior art Laplacian pyramid decomposition methods is that weighted averages are applied when generating Laplacian pyramid levels 64a, 64b, 64c . . . after the first Laplacian pyramid level 64. In particular, for each of the Laplacian pyramid levels 64a, 64b, 64c (which have the indices of 2≤l≤L−1), after the subtraction of its next band-image from its corresponding band-image that results in an intermediate level denoted by X̆ₗ, the weighted averaging is applied to X̆ₗ by:

$${X}_{l} = β * {X}_{l - 1}^{*} + ( 1 - β ) * {\breve{X}}_{l} , 1 < l < L \qquad ( 1 )$$

where Xₗ₋₁ is the previous layer of the Laplacian pyramid, and after a resizing operation to Xₗ₋₁,

$${X}_{l - 1}^{*}$$

is obtained. Xₗ is resulted (current level of the Laplacian pyramid. β is a constant with a value of 0.9, giving the previous layer of the Laplacian pyramid a higher weight. This is because, during the construction of the Laplacian pyramid, the image is iteratively resized to lower resolutions, becoming sharper with each step. As a result, the Laplacian layers at lower resolutions have significantly higher values compared to those generated at higher resolutions. To ensure that the higher-resolution layers still influence and contribute to the combined result, they are assigned higher weights.

For example, to generate the Laplacian pyramid level 64a, its current band-pass image 52a is subtracted by an upsampled version of its next band-image 52b, resulting in X̆₂. Then, the current level of the Laplacian pyramid 56 is calculated as

$${X}_{2} = β * {X}_{1}^{*} + ( 1 - β ) * {\breve{X}}_{2} ,$$

wherein

$${X}_{1}^{*}$$

is the previous layer of the Laplacian pyramid 56 after resizing. The weighted averaging operation is performed for each of the layers of the Laplacian pyramid 56 after the initial level/layer, so the weighted averaging operation is performed L−2 times in total.

Among the generated Laplacian pyramid levels 64, 64a, 64b, 64c . . . higher resolution layers (i.e., those with lower index l) capture fine details, whereas lower resolution layers (i.e., those with higher index l) capture coarse details. In the pyramid fusion, it is expected that the selected image index, obtained through maximum selection from each layer's energy map, is consistent across all layers. However, calculating the energy map directly from a single Laplacian layer would surely result in disparities between Laplacian layers. It will produce poor fusion results, particularly in the glare and fine-textured area, which are a common case in conventional digital microscopy. As the linked Laplacian pyramid decomposition illustrated in FIG. 3 employs the weighted average to gradually introduce the bottom layer information into the upper layer, it allows each layer's energy map to properly exploit both fine and coarse features, resulting in a more consistent image index.

Back to FIG. 2, the Laplacian pyramids 56 generated from the linked Laplacian pyramid decomposition are denoted by Xₗ(i, j, m), where 1≤l≤L, and L is the total number of layers in a pyramid 56, while l is the index of a layer in the pyramid 46. Compared to the Laplacian pyramids 46, the Laplacian pyramids 56 do not contain any color information since grayscale images were used as inputs to the linked Laplacian pyramid decomposition. Then, in Step 58 Gaussian smoothing are conducted to each layer of the Laplacian pyramids 56 based on the following equation, and the Gaussian smoothing is well-known to skilled persons in the art.

$${E}_{l} ( i , j , m ) = G * {X}_{l} ( i , j , m ) \qquad ( 2 )$$

The results of Step 58 are then the energy maps 50 which are denoted by Eₗ(i, j, m). Note that for each of the multiple images in the image sequence 20, there is a corresponding Laplacian pyramid 56, and energy maps 50 are generated for all pixels in all layers of the Laplacian pyramid 56. As mentioned above, the generated energy maps 50 are later used to guide the fusion process of the Laplacian pyramids 46.

In particular, Step 24 of FIG. 1 is shown with more details in FIG. 2, where the Laplacian pyramids fusion is conducted using the following equation:

$${Q}_{l} ( i , j , c ) = \{ \begin{matrix}\frac{1}{N} {\sum }_{m} {P}_{l} ( i , j , c , m ) & if l == L \\ {P}_{l} ( i , j , c , {k}_{l} ) , {k}_{l} ( i , j ) = {arg max}_{m} {E}_{l} ( i , j , m ) & if 1 \leq l < L\end{matrix} \qquad ( 3 )$$

The fused pyramid 60 as a result of Step 24 is denoted by Qₗ(i, j, c), and the fused pyramid 60 has the same number of layers as any one of the Laplacian pyramids 46. Nonetheless, after the Laplacian pyramids fusion, a pixel that has a highest energy among all similar pixels in the multiple images of the image sequence 20 is chosen as a pixel in the fused pyramid 60. The similar pixels here refer to pixels in the multiple images that are related to a same point in the FOV. For example, if there are 100 images in the image sequence 20, a pixel from only one of the 100 images is chosen to be the pixel in the fused pyramid 60 for representing the FOV. It should be noted that as there is a plurality of layers in the fused pyramid 60, for a pixel in the fusion image 30, there are still many similar pixels in the fused pyramid 60 across different layers thereof.

Next, the fused pyramid 60 is applied with a linear function in Step 26 such that dynamic weighting of the fused pyramid 60 is performed, which outputs a weighted pyramid 62 that is denoted by

$${Q}_{l}^{′} ( i , j , c ) .$$

The purpose of the dynamic weighting is to enhance the visual effect (thus providing a better look) of the fusion image 30. Dynamic weighting is performed in order to adjust the weights of layers of the pyramid 60, such that weights of some layers of the fused pyramid 60 are enhanced, while weights of some otter layers of the fused pyramid 60 are reduced. It could be the case for some layers in the fused pyramid 60, their weights remain unchanged. An exemplary linear function for the dynamic weighting in Step 26 is shown below.

$${Q}_{l}^{′} ( i , j , c ) = {Q}_{l} ( i , j , c ) * s ( l ) \qquad ( 4 )$$

where s(l) is defined as follows:

$$s ( l ) = \{ \begin{matrix}1 + ( 1.33 - l / 3 ) * a & if 1 \leq l \leq 4 \\ 1.04 - 0.01 * l & if 5 \leq l < L \\ 1 & if l == L\end{matrix} \qquad ( 5 )$$

where α is the amplification factor, and 0.3<α<1. L is the total number of layers in the fused pyramid 60.

Lastly, to generate the fusion image 30, the weighted pyramid 62 undergoes a reconstruction process in Step 28. The reconstruction of an image from its decomposed components in a Laplacian pyramid is well-known to those skilled in the art, and in summary it starts with the smallest (lowest resolution) image in the Laplacian pyramid, and this image is upsampled to next higher resolution level, and the corresponding Laplacian image at this level is added to the upsampled image. The upsampling and addition process is repeated for each level until the original resolution is reached. In other words, the final reconstructed image which is the fusion image 30 is obtained by combining all the levels of the Laplacian pyramid through the above process along a direction which is reverse to the direction of Laplacian pyramid decomposition.

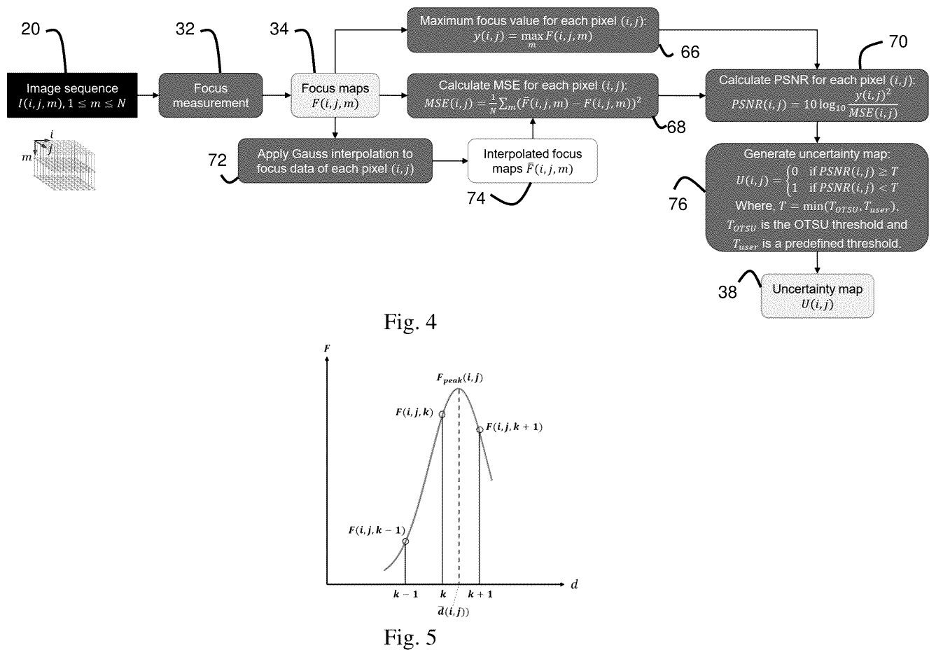

Turning to FIG. 4, in which Step 36 in the depth map estimation path of the method in FIG. 1 is illustrated in detail. The same image sequence 20 as used for the image fusion path is used also as the input for the depth map estimation. The multiple images in the image sequence 20 firstly go through focus measurement in Step 32, and the focus measurement is the measurement of how in focus a pixel is on a given image, i.e., Laplacian operator. The focus measurement is a well-known technique in the art for DFF methods so it will not be described in more details here. The output of Step 32 is a plurality of focus maps 34 denoted by F(i, j, m), where m is the index of the image in the sequence, and i, j are the coordinates of the pixel on orthogonal axes in the FOV. Each focus map 34 corresponds to one image in the image sequence 20, so for example if there are 100 images in the image sequence 20 there are also 100 focus maps 34 created.

The generated focus maps 34 are then processed in separate steps of the method in FIG. 4 for the purpose of obtaining PSNR for pixels in the FOV. In particular, in Step 66 a maximum focus value for each pixel (i, j) is calculated according to the following equation.

$$y ( i , j ) = {max}_{m} F ( i , j , m ) \qquad ( 6 )$$

On the other hand, Gauss interpolation is applied to the focus data of each pixel (i, j) in Step 72 and as a result interpolated focus maps 74 are generated which are denoted by F̅(i, j, m). An exemplary Gaussian curve for the focus data is shown in FIG. 5. For pixel (i, j), the focus values F(i, j, k+1) and F(i, j, k−1), as well as the maximum focus value F(i, j, k), are used to estimate a Gauss function. All the focus data at pixel (i, j) are then re-calculated via the estimated Gauss function as follows.

$$\overline{F} ( i , j , m ) = {F}_{peak} ( i , j ) {e}^{- \frac{{( m - \overline{d} ( i , j ) )}^{2}}{2 σ ( i , j )}} \qquad ( 7 )$$

Consequently, with the obtained interpolated focus maps 74, in Step 68 the MSE for each pixel (i, j) is calculated according to the following equation.

$$MSE ( i , j ) = \frac{1}{N} {\sum }_{m} {( \overline{F} ( i , j , m ) - F ( i , j , m ) )}^{2} \qquad ( 8 )$$

With the MSE information, the PSNR for each pixel (i, j) is calculated in Step 70 according to the following equation.

$$PSNR ( i , j ) = 10 {log}_{10} \frac{{y ( i , j )}^{2}}{MSE ( i , j )} \qquad ( 9 )$$

Based on the PSNR information, the uncertainty map 38 for the FOV can be generated in Step 76 based on the following conditions.

$$U ( i , j ) = \{ \begin{matrix}0 & if PSNR ( i , j ) \geq T \\ 1 & if PSNR ( i , j ) < T\end{matrix} \qquad ( 10 )$$

where T=min(T_{OTSU}, Tᵤₛₑᵣ), and T_{OTSU} is the OTSU threshold and Tᵤₛₑᵣ is a predefined threshold.

The output of Step 76 is the uncertainty map 38 which is denoted by U (i, j). There is only one uncertainty map for the image sequence 20 and it consists of only binary values of 0 and/or 1. Steps 66, 68, 72, 70 and 76 together constitute Step 36 in FIG. 1.

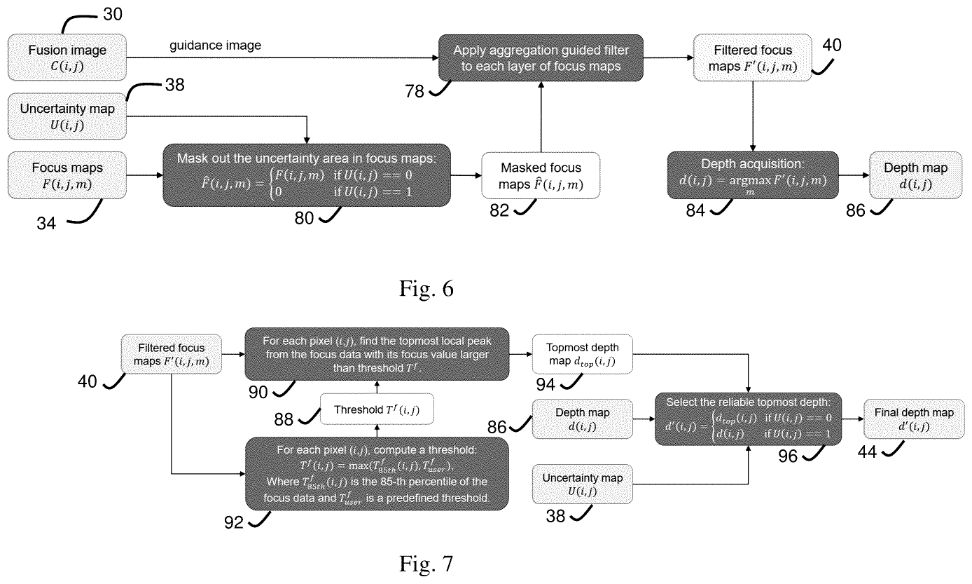

After the uncertainty map 38 is obtained, in Step 37 the uncertainty map 38 together with the fusion image 30 as generated in the image fusion path are used to refine the focus maps 34, resulting in filtered focus maps 40 which are denoted by F′(i, j, m). Details of Step 37 is shown in FIG. 6. In particular, the fusion image 30 as denoted by C(i, j) is used as a guidance image for aggregation guided filter that is applied to each layer of masked focus maps 82 in Step 78. The aggregation guided filter is necessary as the correctly labeled depth pixels are very sparse and the amount of noise present is quite high. Here the guided filter is used to propagate dominant focus responses to the uncertainty area. The edge-preserving property of the guided filter makes it ideal for this edge-sensitive aggregation task. An exemplary guided filtering method that can be used for Step 78 is described in “Guided Image Filtering, Kaiming He, Jian Sun, Xiaoou Tang” (https://people.csail.mit.edu/kaiming/eccv10/eccv10ppt.pdf), the entire content of which is incorporated by reference herein.

The masked focus maps 82 as denoted by \hat{F}(i, j, m) are generated in Step 80 of FIG. 6. In particular, the uncertainty map 38 is used as a mask to mask out all uncertainty areas in the focus maps 34 obtained in Step 32. The masking operation is to avoid the unreliable focus response from uncertainty area (e.g., noise, glare, bokeh, underexposure, and overexposure) to propagate to another area. The masking operation is performed according to the following equation.

$$\hat{F} ( i , j , m ) = \{ \begin{matrix}F ( i , j , m ) & if U ( i , j ) == 0 \\ 0 & if U ( i , j ) == 1\end{matrix} \qquad ( 11 )$$

The filtered focus maps 40 then undergo the depth acquisition operation according to the following equation in Step 84. As a result, the intermediate depth map 86 is generated. It should be noted that the intermediate depth map 86 is not the final depth map 44 in FIG. 1. Rather, the intermediate depth map 86 will further undergo a topmost focus detection to obtain the final depth map 44.

$$d ( i , j ) = {arg max}_{m} {F}^{′} ( i , j , m ) \qquad ( 12 )$$

Details of the topmost focus detection are shown in FIG. 7. The method steps illustrated in FIG. 7 together with Step 84 in FIG. 6 constitute Step 42 of FIG. 1, which is the step of depth acquisition with topmost focus detection. In particular, for each pixel (i, j) in the filtered focus maps 40, a threshold 88 denoted by T^{f}(i, j) is computed in Step 92 according to the following equation.

$${T}^{f} ( i , j ) = max ( {T}_{85 th}^{f} ( i , j ) , {T}_{user}^{f} ) \qquad ( 13 )$$

where

$${T}_{85 th}^{f} ( i , j )$$

is the 85-th percentile of the focus data and

$${T}_{user}^{f}$$

is a predefined threshold.

Then, in Step 90, for each pixel (i,j) in the filtered focus maps 40, the topmost local peak with its focus value larger than threshold T^{f} is found from the focus data. The output of Step 90 is a topmost depth map 94 which is denoted by dₜₒₚ (i, j). The topmost focus detection allows precisely identifying the depth of a raised wire items, such as gold wire in PCB inspection. Nonetheless, applying topmost focus detection alone will result in incorrect depth in the depth map because the pixels within the uncertainty area are usually with weak focus response. For this reason, in the method of FIG. 6 the uncertainty areas in the focus maps are first masked out based on the uncertainty map in Step 80 prior to the topmost focus detection are shown in FIG. 7.

Consequently, in Step 96 either depth data from the intermediate depth map 86, or that from the topmost depth map 94 is selected to be included in the final depth map 44 according to the uncertainty map 38, as illustrated in the equation below.

$${d}^{′} ( i , j ) = \{ \begin{matrix}{d}_{top} ( i , j ) & if U ( i , j ) == 0 \\ d ( i , j ) & if U ( i , j ) == 1\end{matrix} \qquad ( 14 )$$

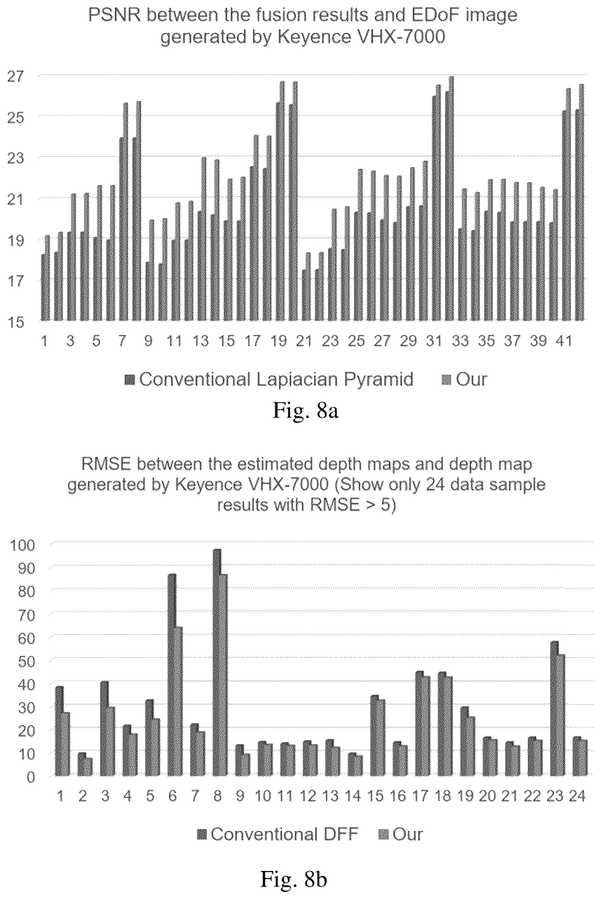

The depth map estimation path of FIG. 1 has thus been described thoroughly. Next, the evaluation and performance analysis of the method of FIG. 1 will be discussed. In an experimental setup, 42 data samples were collected using a Keyence VHX-7000 digital microscope, each of which included a series of multi-focus pictures, a EDOF image and a depth map. The EDOF image generated by Keyence VHX-7000 serves as ground truth for calculating the peak signal noise ratio (PSNR) of fusion results from both the method of FIG. 1 (indicated by “Our” in FIGS. 8a and 8b) and a conventional image fusion method based on Laplacian pyramid (“Wang, Wencheng et al. A Multi-focus Image Fusion Method Based on Laplacian Pyramid. Journal of Computers (2011)”). Also, the depth maps generated by Keyence VHX-7000 serves as ground truth for calculating the RMSE of estimated depth maps from both the method of FIG. 1 and a conventional DFF method (“S. Nayar et al. Shape from focus. IEEE Transactions on Pattern Analysis and Machine Intelligence (1994)”).

FIG. 8a shows the PSNR between the fusion results and EDoF image generated by Keyence VHX-7000. It can be seen from FIG. 8a that compared to the conventional Laplacian Pyramid based image fusion method, the average PSNR is increased by about 1.7. On the other hand, FIG. 8b shows the PSNR between the fusion results and EDOF image generated by Keyence VHX-7000 (only 24 data sample results with RMSE >5 are shown in FIG. 8b). It can be seen from FIG. 8b that compared to the conventional DFF method, the average RMSE is reduced by about 4.5.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

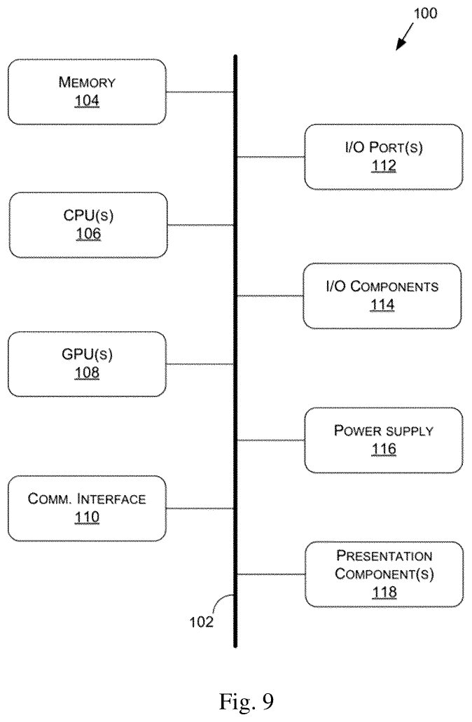

FIG. 9 is a block diagram of an example computing device 100 suitable for use in implementing some embodiments of the present disclosure. Computing device 100 may include a bus 102 that directly or indirectly couples the following devices: memory 104, one or more central processing units (CPUs) 106, one or more graphics processing units (GPUs) 108, a communication interface 110, input/output (I/O) ports 112, input/output components 114, a power supply 116, and one or more presentation components 118 (e.g., display(s)).

Although the various blocks of FIG. 9 are shown as connected via the bus 102 with lines, this is not intended to be limiting and is for clarity only. For example, in some embodiments, a presentation component 118, such as a display device, may be considered an I/O component 114 (e.g., if the display is a touch screen). As another example, the CPUs 106 and/or GPUs 108 may include memory (e.g., the memory 104 may be representative of a storage device in addition to the memory of the GPUs 108, the CPUs 106, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The bus 102 may represent one or more busses, such as an address bus, a data bus, a control bus, or a combination thereof. The bus 102 may include one or more bus types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus.

The memory 104 may include any of a variety of computer-readable media. The computer-readable media may be any available media that may be accessed by the computing device 100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 100. As used herein, computer storage media does not comprise signals per se.

The communication media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the communication media may include wired media such as a wired network or direct-wired connection, and wireless media such as acoustic, RF, infrared and other wireless media. Combinations of any of the above should also be included within the scope of computer-readable media.

The CPU(s) 106 may be configured to execute the computer-readable instructions to control one or more components of the computing device 100 to perform one or more of the methods and/or processes described herein. The CPU(s) 106 may each include one or more cores (e.g., one, two, four, eight, twenty-eight, seventy-two, etc.) that are capable of handling a multitude of software threads simultaneously. The CPU(s) 106 may include any type of processor, and may include different types of processors depending on the type of computing device 100 implemented (e.g., processors with fewer cores for mobile devices and processors with more cores for servers). For example, depending on the type of computing device 100, the processor may be an ARM processor implemented using Reduced Instruction Set Computing (RISC) or an x86 processor implemented using Complex Instruction Set Computing (CISC). The computing device 100 may include one or more CPUs 106 in addition to one or more microprocessors or supplementary co-processors, such as math co-processors.

The GPU(s) 108 may be used by the computing device 100 to render graphics (e.g., 3D graphics). The GPU(s) 108 may include hundreds or thousands of cores that are capable of handling hundreds or thousands of software threads simultaneously. The GPU(s) 108 may generate pixel data for output images in response to rendering commands (e.g., rendering commands from the CPU(s) 106 received via a host interface). The GPU(s) 108 may include graphics memory, such as display memory, for storing pixel data. The display memory may be included as part of the memory 104. The GPU(s) 108 may include two or more GPUs operating in parallel (e.g., via a link). When combined together, each GPU 108 may generate pixel data for different portions of an output image or for different output images (e.g., a first GPU for a first image and a second GPU for a second image). Each GPU may include its own memory, or may share memory with other GPUs.

In examples where the computing device 100 does not include the GPU(s) 108, the CPU(s) 106 may be used to render graphics.

The communication interface 110 may include one or more receivers, transmitters, and/or transceivers that enable the computing device to communicate with other computing devices via an electronic communication network, included wired and/or wireless communications. The communication interface 110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet), low-power wide-area networks (e.g., LoRaWAN, SigFox, etc.), and/or the Internet.

The I/O ports 112 may enable the computing device 100 to be logically coupled to other devices including the I/O components 114, the presentation component(s) 118, and/or other components, some of which may be built in to (e.g., integrated in) the computing device 100. Illustrative I/O components 114 include a microphone, mouse, keyboard, joystick, game pad, game controller, satellite dish, scanner, printer, wireless device, etc. The I/O components 114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 100. The computing device 100 may be include depth cameras, such as stereoscopic camera systems, infrared camera systems, RGB camera systems, touchscreen technology, and combinations of these, for gesture detection and recognition. Additionally, the computing device 100 may include accelerometers or gyroscopes (e.g., as part of an inertia measurement unit (IMU)) that enable detection of motion. In some examples, the output of the accelerometers or gyroscopes may be used by the computing device 100 to render immersive augmented reality or virtual reality.

The power supply 116 may include a hard-wired power supply, a battery power supply, or a combination thereof. The power supply 116 may provide power to the computing device 100 to enable the components of the computing device 100 to operate.

The presentation component(s) 118 may include a display (e.g., a monitor, a touch screen, a television screen, a heads-up-display (HUD), other display types, or a combination thereof), speakers, and/or other presentation components. The presentation component(s) 118 may receive data from other components (e.g., the GPU(s) 108, the CPU(s) 106, etc.), and output the data (e.g., as an image, video, sound, etc.).

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The embodiments of the invention in which an exclusive property or privilege is claimed are defined as follows:

1. A computer-implemented method of fusing multiple images; the multiple images taken at different focal planes on a same field of view; the method comprising steps of:
a) to each color channel of each one of the multiple images, performing Laplacian pyramid decomposition to generate a first pyramid;
b) for each said color channel, fusing the first pyramids of the color channel of the multiple images to obtain a fused pyramid for the color channel under guidance of energy maps respectively corresponding to each one of the multiple mages;
c) performing a dynamic weighting of the fused pyramid to generate a weighted pyramid for each said color channel;
d) reconstructing a channel fusion image for each said color channel from the weighted pyramid; and
e) merging the channel fusion images of all the color channels to obtain a final fused image.

2. The computer-implemented method of claim 1, further comprising a step of:
f) for each one of the multiple images, calculating the energy map using a linked Laplacian pyramid decomposition.

3. The computer-implemented method of claim 2, wherein Step f) comprises:
g) for each one of the multiple images, performing the linked Laplacian pyramid decomposition to generate a second pyramid, during which information of a bottom layer of the second pyramid is gradually introduced to a top layer of the corresponding pyramid by applying weighted averages.

4. The computer-implemented method of claim 2, further comprises, before Step f), steps of converting the one of the multiple images to a grayscale image, and using the grayscale image for performing the linked Laplacian pyramid decomposition.

5. The computer-implemented method of claim 3 wherein Step f) further comprises:
h) conducting Gaussian smoothing to the second pyramid to obtain the energy map for each one of the multiple images.

6. The computer-implemented method of claim 1, wherein in Step b), a pixel that has a highest energy among all similar pixels in the multiple images is chosen as a pixel in the fused pyramid.

7. The computer-implemented method of claim 1, wherein in Step c), a linear function is applied to the fused pyramid, such that weights of a first plurality of layers of the fused pyramid are enhanced, and weights of a second plurality of layers of the fused pyramid are reduced.

8. A computer-implemented method of generating a depth map based on multiple images; the multiple images taken at different focal planes on a same field of view; the method comprising steps of:
a) for each one of the multiple images, conducting focus measurement to generate an initial focus map;
b) estimating an uncertainty map for the multiple images based on the initial focus maps;
c) refining the initial focus maps according to the uncertain map and a fusion image of the multiple images to obtain filtered focus maps; and
d) conducting depth acquisition on the filtered focus maps to generate the depth map.

9. The computer-implemented method of claim 8, wherein Step b) comprises steps of:
e) calculating peak signal-to-noise ratio (PSNR) of each pixel in the field of view based on the initial focus maps; and
f) generating the uncertain map based on results of comparison between the PSNR of each said pixel and a threshold.

10. The computer-implemented method of claim 9, wherein in Step e) the PSNR of each said pixel is calculated based on a mean-square-error (MSE) of the pixel and a maximum focus value of the pixel.

11. The computer-implemented method of claim 8, wherein Step c) comprises steps of:
g) masking out uncertainty areas in the initial focus maps based on the uncertainty map; and
h) applying a guided filter based on the fusion image to the initial fusion maps to obtain the filtered focus maps.

12. The computer-implemented method of claim 11, further comprising a step of:
i) performing a topmost focus detection on the filtered focus maps; and
j) based on a result of the topmost focus detection and the depth map, generating a final depth map.

13. The computer-implemented method of claim 12, wherein Step i) further comprises:
k) finding a topmost local peak for each pixel in the field of view in order to generate a topmost depth map; and
wherein Step j) further comprises:
l) selecting a preferable topmost depth for each said pixel in the field of view based on the uncertainty map; and
m) generating the final depth map based on the preferable topmost depths of the pixels.

14. A computing system comprising:
a) one or more processors; and
b) memory containing instructions that, when executed by the one or more processors, cause the computing system to perform the method according to claim 1.
